(19) United States
(12) Patent Application Publication
(10) Pub. No.: US 2015/0114381 A1
(43) Pub. Date: Apr. 30, 2015

(54) APPRATUS FOR CALIBRATING SLABS OF NATURAL OR AGGLOMERATED STONE MATERIAL

(71) Applicant: Dario TONCELLI, Bassano del Grappa (VI) (IT)

(72) Inventor: Dario Toncelli, Bassano del Grappa (VI) (IT)

(21) Appl. No.: 14/388,539

(22) PCT Filed: Mar. 29, 2013
(86) PCT No.: PCT/IB2013/052538

§ 371 Date: Sep. 26, 2014

(30) Foreign Application Priority Data
Apr. 2, 2012 (IT) TV2012A000052

(51) Int. Cl. B28D 1/20

(52) U.S. Cl. CPC B28D 1/20
USPC 125/5

(57) ABSTRACT

An apparatus (12) for calibrating slabs of agglomerated or natural stone material comprises at least one calibrating unit (15) provided with a calibrating head which is rotatable about a first rotational axis (16) perpendicular to a working surface (18). The calibrating head (14) comprises calibrating roller tools (24) with rotational axes (28) which are radially arranged around the said first axis (16) for working a slab arranged on said working surface and sliding with a relative movement under the head. Each tool (24) is mounted on a spindle unit comprising in combination: a spindle body passed through by a spindle shaft (30) for rotation of the tool (24) about its rotational axis (28); a motor unit (36) with a motor output shaft (42) having its own rotational axis (43), and a kinematic transmission (48) connected between the motor output shaft (42) and spindle shaft (30) for motorized rotation of the tool. The machine is characterized in that the motor unit (36), the kinematic transmission (49) and the spindle body with the spindle shaft (30) carrying the tool are mutually arranged so that the rotational axis (43) of the motor shaft (42) and the rotational axis (28) of the tool are parallel to each other and spaced in a direction along the first rotational axis (16).

The present invention relates to an apparatus for calibrating slabs of natural or agglomerated stone material.

In particular, the present invention relates to apparatus for calibrating slabs having at least one calibrating unit comprising a support structure for spindles. The support structure is able to rotate about a rotational axis perpendicular to a working surface, and the spindles, which are provided with a calibrating tool, are arranged with their rotational axis radial with respect to the rotational axis of the support structure. Generally, the working surface comprises a conveyor belt which is supported by a bench and designed to move and support the slabs during machining.

A first embodiment of this type of apparatus envisages one or more calibrating units each comprising a fixed structure which is arranged transversely and mounted in bridge fashion with respect to the working surface and on which the support structure is mounted so that the latter is movable vertically, for example by means of linear electric actuators of the recirculating ball screw type. The rotation of the support structure may be achieved in a manner known per se for example by means of an electric motor.

Spindles provided with calibrating tools are mounted along the bottom circumferential edge of the mobile structure, the rotational axes of which being arranged radially with respect to the rotational axis of the support structure and equidistant along the circumference.

Generally each spindle comprises a spindle motor provided with a spindle shaft on which the calibrating tool is coaxially mounted.

The calibrating tool may comprise a calibrating roller or a set of calibrating discs.

Apparatus of this type are described for example in European patent applications EP 2255924 and EP 2322320 and in Italian patent IT 1314473.

In order for the slab to be efficiently machined, each calibrating tool, during its rotational movement about the axis of the support structure, must always be in contact with the slab and must never move out completely from the profile thereof.

In other words two conditions must be present at the same time:
the outer machining diameter of the calibrating tools, understood as meaning the diameter of the circumference which joins the outermost points of the tools, must be greater than the width of the slab to be calibrated; and
the inner machining diameter of the calibrating tools, understood as meaning the diameter of the circumference which joins the innermost points of the tools, must be smaller than the width of the slab to be calibrated.

For example, in the case where the arrangement of the spindles is symmetrical with respect to the axis of rotation of the support structure, the outer distance of two opposite calibrating tools must be greater than the width of the slab so as to be able to calibrate the full width of the slab.

Moreover, the calibrating tools must not move entirely outside the two side edges of the slab, remaining always in contact with the slab.

In fact, should the inner machining diameter of the calibrating tools be greater than the width of the slab being processed, the calibrating tools would move outside of and then return back into the profile of the slab: when, after moving outside, they come back into contact with the slab, they would leave clearly visible and aesthetically unacceptable scoring marks.

The machines described above, although widely used, are not without drawbacks.

In fact, should a slab manufacturer need to machine slabs of varying width, machines with different dimensions must be used, since a given calibrating unit configuration corresponds to a precise width of machinable slabs.

Moreover, if we consider for example machining of a slab with a very small width, performed therefore with a very small outer diameter of the calibrating tools, a very compact arrangement of the spindles is required and this cannot always be easily achieved in view of the coaxial arrangement of the spindle motor and the calibrating tool.

It can therefore be understood that a slab manufacturer must therefore necessarily have available several calibrating machines depending on the dimensions of the slabs which are to be machined. This results in a significant increase in costs and little flexibility. At the same time the manufacturers of calibrating machines are obliged to offer a range of machines comprising machines which are substantially similar, but with different dimensions.

In Italian patent IT0000242138 this technical problem is dealt with by providing a calibrating unit which is able to move in a direction transverse to the direction of the slab feeding movement, wherein the outer machining diameter of the calibrating tools is smaller than the width of the slab. However, the machine does not allow completely uniform machining of the slab since, along the side edges, where reversal of the movement of the calibrating unit occurs, intermittent machining creates slightly opaque zones which in certain types of slabs are not acceptable.

The object of the invention is therefore that of overcoming the drawbacks of the prior art.

A first task of the present invention is to provide an apparatus for calibrating slabs which is compact, by means of an efficient arrangement of its component parts. In particular, an object of the invention is also to provide spindles for rotation of the tools which are also able to extend adequately towards the centre of the rotating head.

A further task of the present invention is to provide a machine for calibrating slabs which, by means of an efficient arrangement of its component parts, allows easy machining of slabs of different sizes.

In view of this object and the tasks mentioned above the idea which has occurred is to provide an apparatus according to claim 1.

The apparatus for calibrating slabs of natural or agglomerated stone material according to the present invention comprises at least one calibrating unit provided with a calibrating head which is rotatable about a first rotational axis perpendicular to a working surface. The calibrating head comprises calibrating roller tools with rotational axes which are radially arranged around the first axis for working a slab arranged on the working surface and sliding with a relative movement under the head. Each tool is mounted on a spindle unit comprising in combination:

a spindle body passed through by a spindle shaft for rotation of the tool about its rotational axis;

a motor unit with a motor output shaft having its own rotational axis; and

a kinematic transmission connected between the motor output shaft and the spindle shaft for motorized rotation of the tool.

The apparatus is characterized in that the motor unit, the kinematic transmission and the spindle body with the spindle shaft carrying the tool are mutually arranged so that the rotational axis of the motor shaft and the rotational axis of the tool are parallel to each other and spaced in a direction along the first rotational axis.

In accordance with a further aspect of the present invention, owing to the particular arrangement of the motor means it is possible to provide an apparatus in which the means for fixing the calibrating roller tool to the second end of the spindle shaft can be fixed onto corresponding spindle shafts, by means of releasable fixing means, at at least two different distances from the first rotational axis of the head.

Advantageously, the fixing means may comprise a flange adapted to be fixed to the spindle shaft and a spacer which is adapted to be fixed to the flange and on which the calibrating tool is mounted. It is thus possible to mount on the apparatus different types of spacers, or the spacer or the spacer and the flange may be mounted in different configurations, so that with a single apparatus it is possible to calibrate slabs of different sizes.

The characteristic features and advantages of a calibrating apparatus designed in accordance with the principles of the present invention will emerge more clearly from the description below of a number of examples of embodiment provided by way of a non-limiting example, with reference to the accompanying drawings in which:

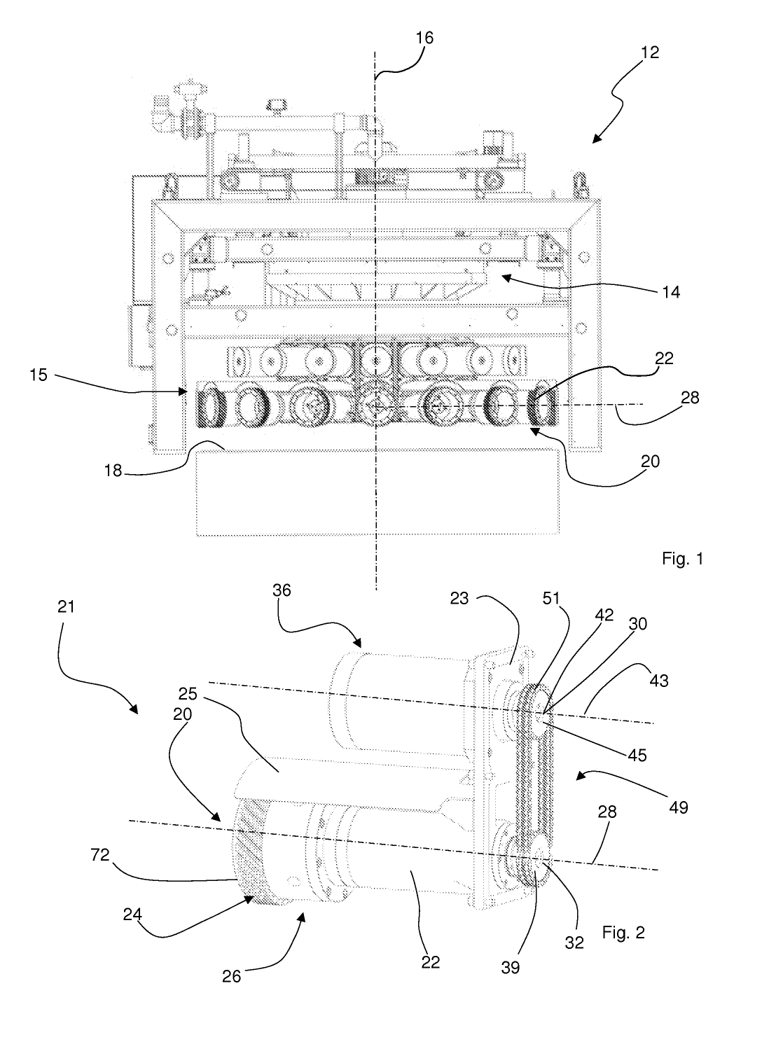

FIG. 1 shows a front view of an apparatus according to the present invention;

FIG. 2 shows an enlarged view of a spindle of the apparatus shown in FIG. 1;

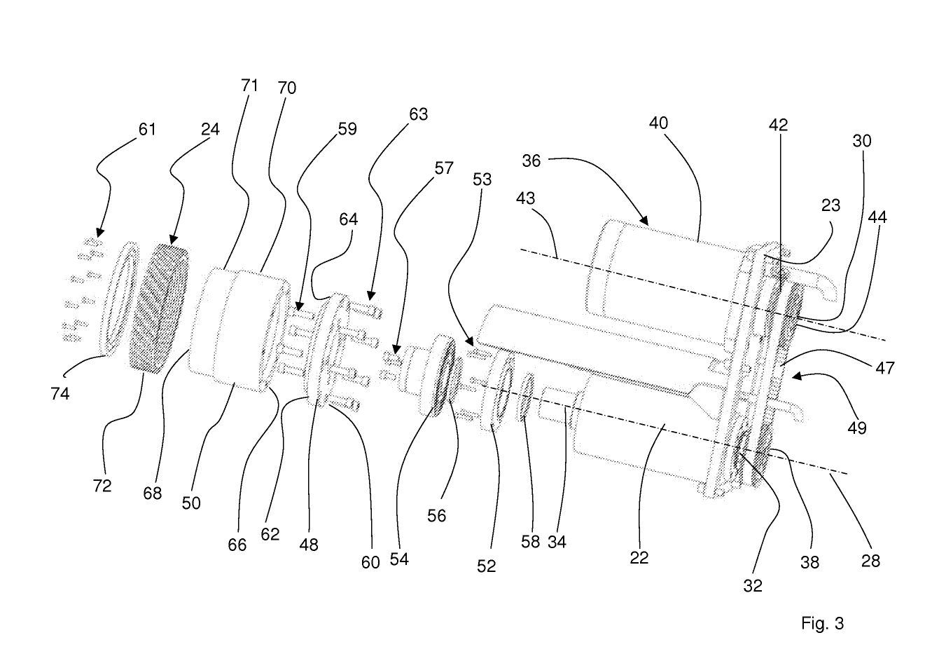

FIG. 3 shows a cross-sectional view of the spindle according to FIG. 2, in a partially disassembled condition;

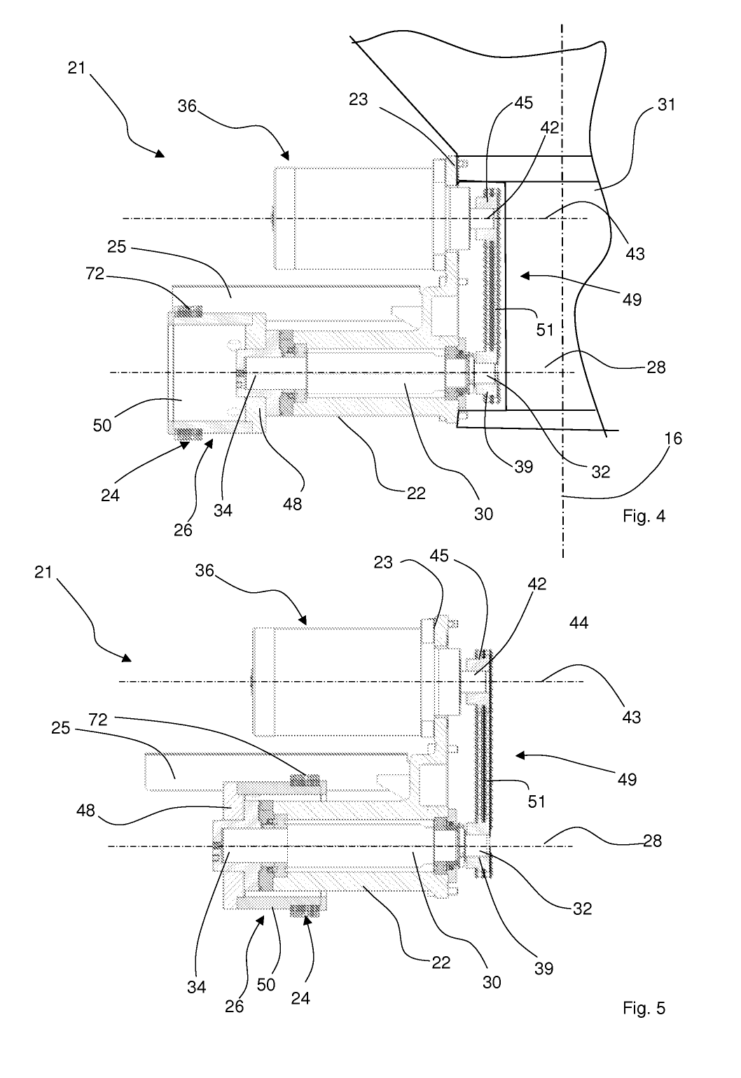

FIG. 4 shows a cross-sectional view of a spindle assembled in a first configuration;

FIG. 5 shows the spindle according to FIG. 4, assembled in a second configuration;

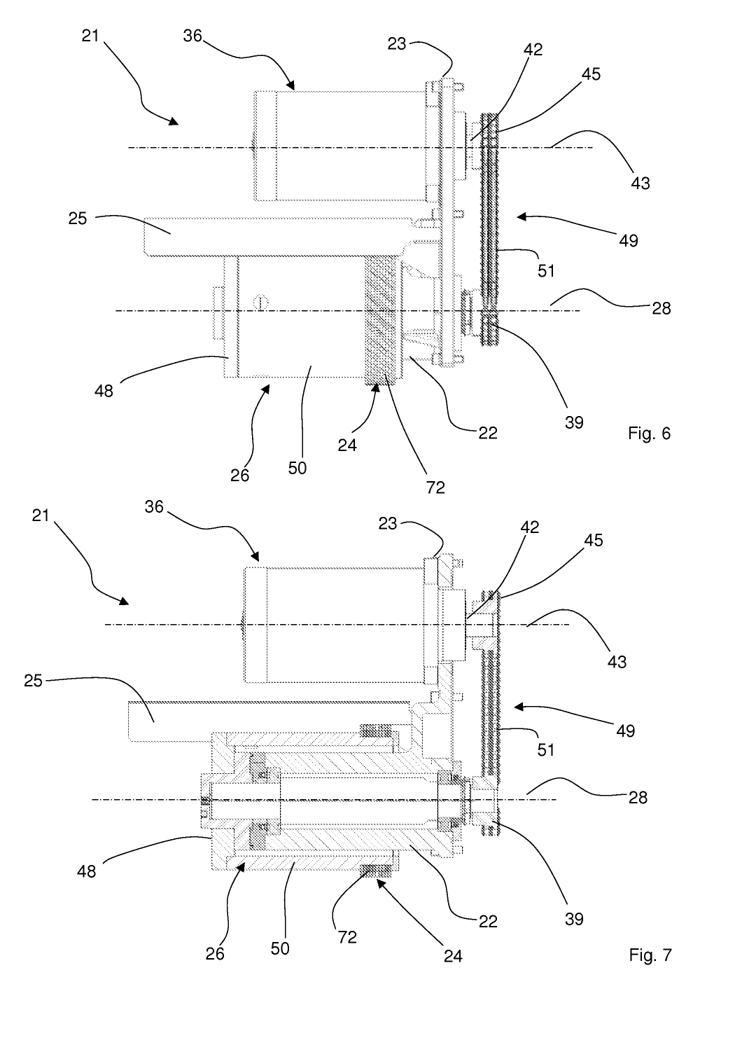

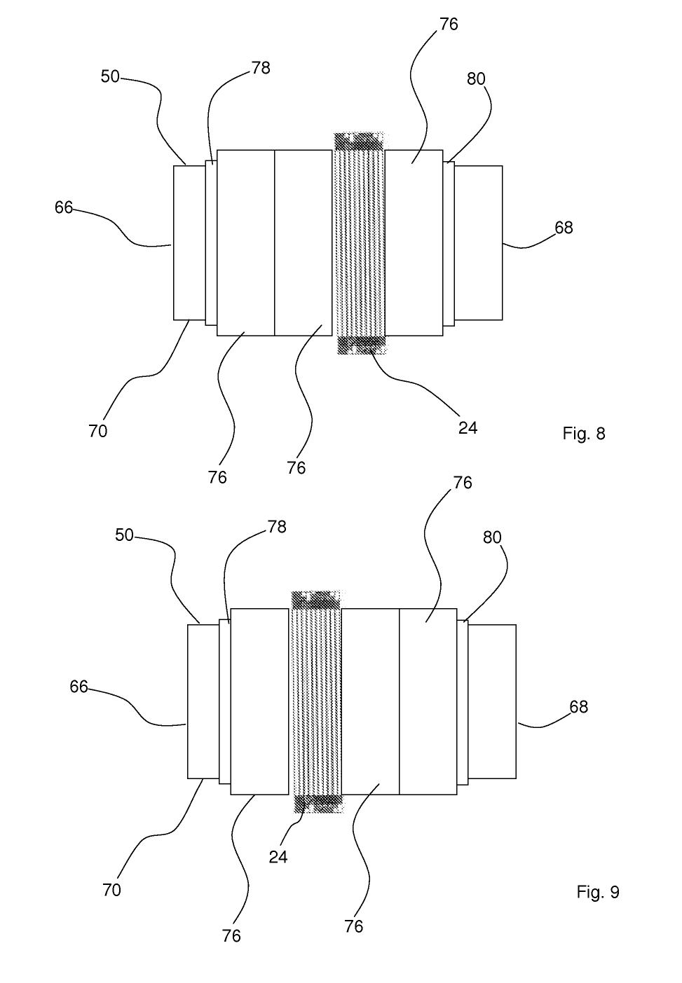

FIGS. 6 and 7 show, respectively, a side view and a cross-sectional side view of a spindle of an apparatus according to the present invention;

FIGS. 8 and 9 show a particular embodiment of a component of an apparatus according to the present invention; and

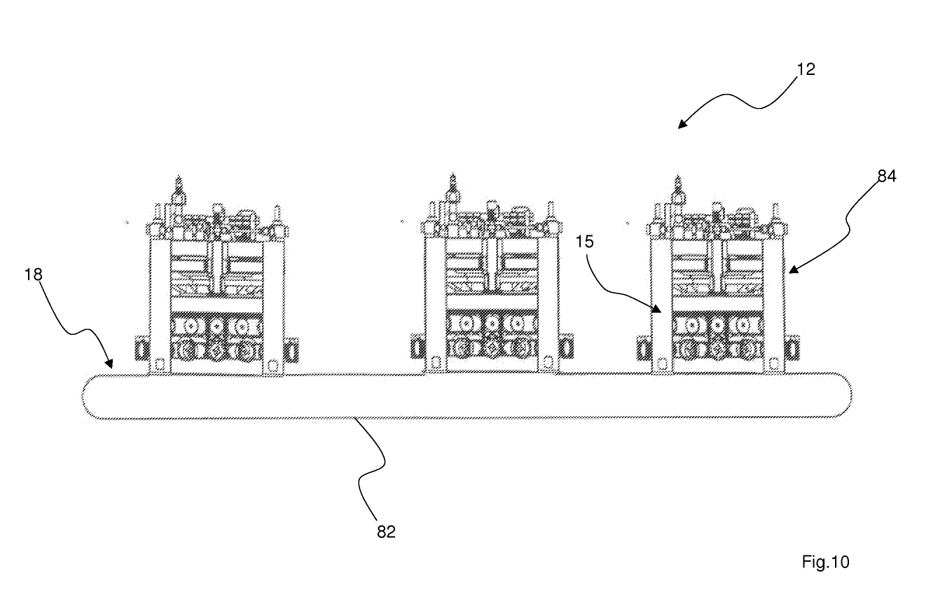

FIG. 10 shows a side view of an apparatus according to the present invention.

FIG. 1 shows an apparatus 12 for calibrating slabs of agglomerated or natural stone material comprising at least one calibrating unit 15 with a support structure or head which is rotatable about a first rotational axis 16 perpendicular to a working surface 18. The apparatus comprises means for relative sliding of the slab and the machining head. The support structure 14 comprises at least one spindle 20.

As can be seen more clearly in FIG. 2, the spindle 20 is designed to rotate a calibrating tool 24 about a second rotational axis 28 arranged radially with respect to the first rotational axis 16. The spindle 20 is connected to a motorized shaft 42 of motor means 36. The motorized shaft is designed to rotate about an associated third rotational axis 43. The spindle comprises a spindle body 22 and a spindle shaft 30 having a first end 32 and a second end 34, wherein the first end 32 is connected to the motorized shaft 42 and the second end 34 is connected to a calibrating tool 24 via fixing means 26.

The calibrating tool 24 is a roller tool. Here “roller tool” is understood as meaning a tool with a cylindrical peripheral surface which acts tangentially on the surface to be machined. This cylindrical peripheral surface will have an axial thickness suitable for the desired machining operation, as may be easily imagined by the person skilled in the art.

The spindle shaft 30 has a rotational axis coinciding with the second rotational axis 28, where the second rotational axis 28 is parallel and spaced with respect to the third rotational axis 43. A kinematic transmission 49 connects the motor shaft of the motor unit to the spindle shaft. Advantageously, the kinematic transmission 49 comprises a pair of wheels and a belt or chain.

As can be seen in FIG. 2, the spindle 20, the motor unit and the kinematic transmission 49 form a spindle unit (denoted generally by 21). Advantageously, this spindle unit 21 is U-shaped, with arms of the U (formed by the motor unit and by the spindle) which, once mounted on the head, are arranged radially with respect to the first rotational axis 16 and towards the outside of the head (as can be seen in FIG. 1).

As can be seen again in FIG. 2, advantageously the spindle body is extended laterally, in a position close to the said first rotational axis 16 of the head, by a plate 23 for supporting the motor unit 36. This plate 23 is intended to perform fixing of the spindle unit to a central shaft for rotation of the head about the said first axis 16. The spindle units are thus modular and may be easily installed on the head in the desired number, as will become clear below.

As can be seen in FIG. 1, the spindle units advantageously consist of a plurality and are arranged radially about the first rotational axis 16 so as to form a tool plane which is arranged facing the working surface, and a parallel overlying plane of the motor units. The arrangement of the motors and tools may be defined as being of the “radial superimposed-plane” type.

As can be clearly seen again in FIG. 1, the distance between the tool plane and the plane of the motor units may be minimal, advantageously with only a thin protective screen 25 (consisting for example of shaped sheet metal) which separates the spindle with the tool from the motor unit in order to prevent the material removed during lapping from being propelled by the tool towards the motor unit.

In FIG. 3 a first embodiment of the present invention is shown, in the partially disassembled condition. The spindle 20 comprises a shaft 30, which is inserted inside the spindle body 22, wherein the first end 32 and the second end 34 project from the spindle body 22. During use, the first end 32 is directed towards the first rotational axis 16.

According to a possible embodiment shown in FIG. 3, the first end 32 is connected to the motorized shaft 42 of the motor means 36 via the kinematic transmission 49 formed by belt means. For this purpose, the first end 32 is equipped with a first pulley wheel 38 and the motorized shaft 42 is equipped with a second pulley wheel 44. The first and the second pulleys 38, 44 are connected together by a belt 47 for transferring the rotational movement between the motorized shaft 42 and the shaft 30.

The belt 47 may be a flat belt, a trapezoidal belt or a toothed belt.

With reference to the embodiments shown in FIGS. 4 to 7, the first end 32 is connected to the motorized shaft 42 of the motor means 36 via the kinematic transmission 49 formed by chain means. For this purpose, the first end 32 is equipped with a first ring gear 39 and the motorized shaft 42 is equipped with a second ring gear 45. The first and the second ring gears 39, 45 are connected together by a chain 51 designed to transfer the rotational movement between the motorized shaft 42 and the shaft 30.

FIG. 4 also shows in schematic form the shaft 31 of the head which rotates about the main axis 16 and which radially supports the spindle units.

The person skilled in the art may easily imagine other embodiments of the kinematic transmission (for example gears, friction wheels, etc.). The motor means 36 may be an electric motor directly coupled to the motor shaft or a reduction gear.

Advantageously, the second rotational axis 28 of the shaft 30 and the third rotational axis 43 of the motorized shaft 42 lie in a same radial plane so that the second rotational axis 28 lies between the working surface 18 and the third rotational axis 43. In other words, the motor means 36 are situated, during use, above the calibrating tool 24.

According to alternative embodiments of the present invention, the second rotational axis 28 and the third rotational axis 43 are parallel, but do not lie in the same radial plane.

On the second end 34 of the draft 30 are provided the fixing means 26.

According to a possible embodiment of the present invention, the fixing means 26 comprise a flange 48 and a spacer 50 which is fixed to or is integral with the flange 48.

As can be clearly seen in FIG. 3, the fixing means 26 may also comprise:
a ring 51 fixed in a manner known per se (for example by means of screws 53) onto the spindle body 22 so as to surround radially the second end 34 of the shaft 20 which therefore projects from the ring 52; and
a nose-piece 54 fixed (for example by means of screws 57) to the second end 34 of the shaft 30; a dust stop ring 56 may be arranged between said ring 52 and said nose-piece 54.

Advantageously a seal 58 may be arranged between ring 52 and spindle body 22.

According to a possible embodiment of the present invention the flange 48 is fixed in a manner known per se, for example by means of screws 59, to the nose-piece 54.

The connection between spacer 50 and flange 48 may be performed in a manner known per se by means of screws 63.

According to a possible embodiment of the present invention, the flange 48 may be in the form of a circular rim with a first connection surface 60 and a second connection surface 62.

A seat 64 for receiving an end edge of the spacer 50 may be provided on the peripheral surface of the second connection surface 62.

The spacer 50 may be in the form of a hollow cylinder having a first base or end 66, a second base or end 68, and an outer surface 70, and adapted to receive inside it at least partially the spindle body 22, as will be clarified below.

According to a possible embodiment of the present invention, the first base or end 66 of the spacer 50 is adapted to be fixed onto the second connection surface 62 of the flange 48. Fixing may be performed in a manner known per se, for example by means of screws. The calibrating tool 24 is fixed onto the outer surface 70 of the spacer 50. Advantageously the spacer has a seat 71 at its free end for axially mounting the tool 24.

The calibrating roller tool 24 may be formed by a single disc tool 72 of suitable thickness or a plurality of disc tools 72 which are pack-fitted on the spacer 50. Advantageously, the disc tools are in the form of thin circular crown elements, as can be clearly seen for example in FIG. 4.

The calibrating tool 24 may be locked in position by means of a stop element 74 which is fixed in a known manner to the second base or end 68 of the spacer 50, for example by means of screws 61.

The calibrating tool 24 is of the known type, advantageously with a diamond-coated profile.

According to the embodiment shown in FIGS. 2-4, the spacer 50 may be mounted projecting from the spindle 20.

The structure of the spindle 20 described above is such that the spindle 20, and in particular the flange 48 with the spacer 50, may be assembled in different ways such that the calibrating tool 24 may be positioned in at least two positions along the rotational axis 28 of the spindle 20.

In particular, the flange 48 and the spacer 50 are assembled together to form a cup element which may be mounted both projecting on the nose-piece 54 (FIG. 4) and axially inverted in order to receive the nose-piece 54 and part of the spindle body (FIG. 5).

In particular, in this second position the flange 48 has been mounted on the nose-piece 54 with the first connection surface 60 directed outwards and the second connection surface 62 directed towards the first rotational axis 16. The seat 64 is adapted to receive the spacer 50 and is therefore directed towards the first rotational axis 16. The spacer 50 is arranged so that the first base 66 fixed to the flange 48 is directed outwards.

It is therefore clear that the spindle 20 of the calibrating apparatus 12 may be easily disassembled and reassembled in at least two different ways in order to calibrate at least two different widths of slabs: a first slab (configuration shown in FIG. 4) and a second slab narrower than the first slab (configuration shown in FIG. 5).

According to alternative embodiments of the present invention the flange 48 may not have a seat 64 adapted to receive the spacer 50.

In this case there is no need to overturn the flange 48 in order to mount the flange 48/spacer 50 assembly for the machining of slabs of varying widths.

Therefore the calibrating tool 24 may be positioned:
at a distance from the first rotational axis 16 greater than the distance at which the flange 48 is positioned (FIG. 4); and
at a distance from said first rotational axis 16 smaller than the distance at which the flange 48 is positioned (FIG. 5).

The embodiment in FIGS. 6 and 7 shows a spindle 20 comprising a spacer 50 similar to that described above (spacer 50, FIGS. 4 and 5), but with a greater length.

According, therefore, to a possible embodiment of the present invention, adaptation for machining a particular width of a slab may be performed by replacing the spacer 50 with a second, longer spacer 50. The spacer 50 may be mounted projecting or partially covering the spindle body 22 so that the calibrating tool 24 may be positioned:
at a distance from the first rotational axis 16 greater than the distance at which the flange 48 is positioned; and
at a distance from said first rotational axis 16 smaller than the distance at which the flange 48 is positioned (FIG. 6).

According to an alternative embodiment of the present invention the spacer 50 is designed to receive the calibrating tool 24 in at least two positions at a different distance from the first vertical axis 16. In this case the spacer 50 may be provided with two separate seats.

Advantageously, according to the embodiment shown in FIGS. 8 and 9, the spacer 50 may comprise spacer rings 76 which are provided on the outer surface 70 and pack-mounted between retainers 78, 80. For example, the seat 71 on the outer side of the spacer 50 may be formed with a greater axial length than the tool and the spacer rings may be mounted on the seat together with the tool.

The calibrating tool 24 may be easily assembled in different positions on the outer surface 70 of the spacer 50 by displacing or replacing the spacer rings 76. The tool 24 may be keyed onto the spacer 50 by means of a key/tongue or simply by means of the frictional force generated by tightly packing together the spacer rings 76 and the calibrating tool 24.

From the above description it is clear that the calibrating tool 24 may be positioned as far as possible displaced towards the centre of the support structure 14 and therefore at the minimum possible distance from the first vertical axis of rotation 16 of the mobile structure 14. The apparatus 12 in this configuration may be advantageously adapted to machine, for example, slabs of limited width, for example 1460 mm.

By mounting for example a spacer 50 which is shorter than in the preceding case, the calibrating tool is located at a greater distance from the first vertical axis of rotation 16 of the support structure 14. In this way the apparatus may be advantageously adapted to machine slabs with an intermediate width, for example slabs which are 1660 mm wide.

By mounting a spacer 50 in a projecting manner, namely mounted on the opposite side, towards the outside of the mobile structure 14, it no longer contains internally the spindle shaft 30 and the spindle body 22, but acts as an extension of the spindle shaft 30 itself. The calibrating tool 24 is therefore located at a greater distance from the first vertical axis of rotation 16 of the support structure 14 than in the preceding cases. The apparatus is thus advantageously adapted to machine slabs which are even wider, for example slabs with a width of 2160 mm.

FIG. 10 shows a side elevation view of an apparatus 12 composed of a working surface on which a conveyor belt 82 for moving the slabs is mounted. Three calibrating units 15 are arranged in series on the working surface and each comprise a gantry frame 84 which is mounted transversely with respect to the support surface 18 and to which the support structure 14 is connected.

The support structure 14 may be vertically mobile and moved by means of linear actuators of the recirculating ball screw type situated at the four corners of the structure.

Sixteen spindles arranged radially are advantageously mounted in the bottom part of the mobile structure along its peripheral edge.

According to an embodiment of the present invention the calibrating machine 12 described comprises for example spindles 20 which are designed to machine rough slabs with a width of 1460 mm, 1660 mm and 2160 mm so as to obtain subsequently finished slabs which, after trimming, have a width of 1400 mm, 1600 mm and 2100 mm, respectively

Instead, in accordance with another alternative configuration of an apparatus according to the present invention, calibrating spindles 20 are provided with dimensions such as to be able to machine a series of slabs of smaller width and precisely slabs with a width of 1260 mm, 1460 mm and 1660 mm so as to be able to obtain finished trimmed slabs with a width of 1200 mm, 1400 mm and 1600 mm, respectively. The spindles may be, for example, fourteen in number.

The advantages which can be achieved with an apparatus according to the present invention are therefore evident. In particular, owing to the compact structure of the apparatus, which can be obtained with the above-described arrangement of the motor means, it is possible to achieve an efficient arrangement of the machine components. Owing to the efficient arrangement of the machine components, it is possible to machine easily slabs with different dimensions in the manner described further above.

Owing to the innovative principles of the invention, it is possible to mount a tool which can be radially repositioned along the axis of the spindle up to a minimum distance from the main rotational axis of the head. Moreover, advantageously, the rotating head has smaller overall dimensions in the axial direction, which also results in lesser stressing due to the centrifugal force.

The structure described results in more efficient cooling of the spindle motor since the motor, the transmission and the calibrating-tool support structure are separated from each other by air gaps.

There is also the possibility of improved noise insulation since, owing to the separation between spindle and motor and their position, the motor unit may be easily isolated in a sound-proofing structure.

With regard to the embodiments described above, the person skilled in the art may, in order to satisfy specific requirements, make modifications to and/or replace elements described with equivalent elements, without thereby departing from the scope of the accompanying claims.

For example, the apparatus 12 may be provided with a different number of calibrating units, for example four or five.

A different, i.e. smaller or greater, number of calibrating spindles 20 could be provided. Owing to the modular structure of the spindle unit it is possible to vary the number of said spindle units also on the same head structure, by simply mounting fewer of them than the maximum number envisaged, keeping them uniformly distributed around the axis 16.

The spacers 50 could also have different lengths so that with a single apparatus it is possible to calibrate slabs with four or more different widths, by simply choosing the spacer suitable for the specific slab size from the set of spacers of different length.

The flange 48 and the spacer 50 may be also formed as one piece, for example so as to form a cup element which can be advantageously mounted in the two positions shown in FIGS. 4 and 5 so as to vary the position of the respective tool.

1. Apparatus (12) for calibrating slabs of natural or agglomerated stone material comprising at least one calibrating unit (15) provided with a calibrating head which is rotatable about a first rotational axis (16) perpendicular to a working surface (18), the calibrating head (14) comprising calibrating roller tools (24) with rotational axes (28) which are radially arranged around said first axis (16) for working a slab arranged on said working surface and sliding with a relative movement under the head, each tool (24) being mounted on a spindle unit comprising in combination:
a spindle body passed through by a spindle shaft (30) for rotation of the tool (24) about its rotational axis (28);
a motor unit (36) with a motor output shaft (42) having its own rotational axis (43), and
a kinematic transmission (49) connected between the motor output shaft (42) and the spindle shaft (30) for motorized rotation of the tool,
characterized in that the motor unit (36), the kinematic transmission (49) and the spindle body with the spindle shaft (30) carrying the tool are mutually arranged so that the rotational axis (43) of the motor shaft (42) and the rotational axis (28) of the tool are parallel to each other and spaced in a direction along the first rotational axis (16).

2. Apparatus (12) according to claim 1, characterized in that the spindle unit has a generally U-shaped form, with arms of the U which are arranged radially in relation to the first rotational axis and towards the outside of the head.

3. Apparatus (12) according to claim 1, characterized in that the roller tools (24) can be fixed onto the corresponding spindle shafts (30), by means of releasable fixing means (26), at least two different distances from the first axis (16) of rotation of the head.

4. Apparatus (12) according to claim 1, characterized in that in each spindle unit, the axis (28) of rotation of the tool and the rotational axis (43) of the motor shaft (42) lie in the same plane radial to the first axis (16) of rotation of the head, with the rotational axis (28) of the tool that is comprised between the working surface (18) and the rotational axis (43) of the motor shaft.

5. Apparatus (12) according to claim 1, characterized in that the kinematic transmission comprises a drive belt or chain (47) arranged between respective wheels mounted on ends of the motorized shaft (42) and the spindle shaft (30) which face said first rotational axis (16).

6. Apparatus (12) according to claim 1, characterized in that the calibrating tool (24) is mounted on the spindle shaft (30) by means of axial positioning, in between, of a spacer (50) for adjusting the position of the tool along said second axis (28).

7. Apparatus (12) according to claim 6, characterized in that said spacer (50) is fixed onto the spindle shaft by means of a radial flange (48), said calibrating tool (24) being adapted to be mounted on said spacer (50).

8. Apparatus (12) according to claim 6, characterized in that said spacer (50) is a hollow cylinder, adapted to contain at least partially the spindle body (22).

9. Apparatus (12) according to claim 8, characterized in that the spacer (50) is adapted to be selectively assembled:
axially projecting on the spindle shaft with said calibrating tool (24) positioned at a distance from the first rotational axis (16) greater than the distance at which the spacer is fixed onto the spindle shaft (30); and
axially on the spindle shaft so as to partially receive the spindle body (22), said calibrating tool (24) being positioned at a distance from said first rotational axis (16) smaller than the distance at which the spacer is fixed onto the spindle shaft (30).

10. Apparatus (12) according to any one of claims 6 to 9, characterized by comprising a set of spacers (50, 501) having different lengths and being mountable alternatively between said spindle shaft and said tool.

11. Apparatus (12) according to any one of claims 6 to 10, characterized in that the spacer (50, 501) is adapted to receive on itself the calibrating tool (24) in at least two positions at a different distance from the first vertical axis (16).

12. Apparatus (12) according to claim 11, characterized by comprising spacer rings (76) provided on the external surface (70) of the spacer and pack-mounted between retainers (78, 80), said calibrating tool (24) being adapted to be assembled in different positions on the external surface (70) of the spacer (50) by arranging the spacer rings (76) in different positions.

13. Apparatus (12) according to claim 1, characterized in that the spindle body is extended laterally, in a position close to said first rotational axis of the head, by a plate for supporting the motor unit (36) and intended to fix the spindle unit to a central shaft for rotation of the head about said first axis (16).

14. Apparatus (12) according to claim 1, characterized in that said spindle units are a plurality, radially arranged around the first rotational axis (16) so as to form a tool plane arranged facing the working surface and a parallel overlying plane of the motor units.
